(19) United States
(12) Patent Application Publication
(10) Pub. No.: US 2014/0068760 A1
(43) Pub. Date: Mar. 6, 2014

(54) Method, System and Computer Storage Medium for Rights Management

(71) Applicant: Tencent Technology (Shenzhen) Company Limited, Shenzhen City (CN)

(72) Inventors: Yu Wang, Shenzhen City (CN); Bin Wang, Shenzhen City (CN)

(73) Assignee: Tencent Technology (Shenzhen) Company Limited, Shenzhen City (CN)

(21) Appl. No.: 14/078,985

(22) Filed: Nov. 13, 2013

Related U.S. Application Data
(63) Continuation of application No. PCT/CN2012/077634, filed on Jun. 27, 2012.

(30) Foreign Application Priority Data
Oct. 31, 2011 (CN) 201110337624.9

(51) Int. Cl. G06F 21/57

(52) U.S. Cl. CPC G06F 21/57
USPC 726/21

(57) ABSTRACT

A method, system and non-transitory computer storage readable medium for rights management are disclosed. The method for rights management includes the following steps: acquiring operation requests; querying from a pre-created rights list according to the operation request, and returning the corresponding processing result; and executing a corresponding operation according to the processing result. According to the above method, system and non-transitory computer readable storage medium for rights management, the corresponding processing result is obtained by querying from the pre-created rights list according to an operation request, and a corresponding operation is performed according to the processing result, without classification management of various resources or various operations, instead using the unified management, which reduces the complexity of rights management and improves the convenience of management.

### CROSS-REFERENCE TO RELATED APPLICATIONS

This application is a continuation of International Application No. PCT/CN2012/077634, filed Jun. 27, 2012, which designates inter alia the United States, and which claims priority to Chinese Patent Application No. 201110337624.9, filed on Oct. 31, 2011, the disclosures of which are hereby incorporated in their entireties by reference.

### FIELD OF THE INVENTION

The present invention generally relates to computer technology, and more particularly relates to a method and system for rights management, and a non-transitory computer readable storage medium for rights management.

### BACKGROUND OF THE INVENTION

In an existing active defense system, various resources of the entire Windows, such as system files, registry, progress and network, are controlled to some extent. This includes creating a dynamic simulation anti-virus system, automatically and accurately determining new virus, monitoring and reporting program behaviors, automatically extracting characteristic values to realize multiple defense, and visually displaying monitoring information.

However, there are problems such as redundant classifications and disunity of management in the existing active defense system. The rights management is complex and inconvenient.

### SUMMARY OF THE INVENTION

Hence, it is highly desirable to provide a method, system and computer readable storage medium for rights management to reduce the complexity of rights management and improve the convenience of management.

According to one aspect of the invention, a method for rights management includes the following steps: acquiring an operation request; querying from a pre-created rights list according to the operation request, and returning the corresponding processing result; and executing a corresponding operation according to the processing result.

According to one further aspect of the invention, a system for rights management includes a request acquiring module, a query module, and an execution module. The request acquiring module is configured to acquire an operation request.

The query module is configured to query a pre-created rights list according to the operation request, and return the corresponding processing result. The execution module is configured to execute a corresponding operation according to the processing result.

According to a still further aspect of the invention, a non-transitory computer readable storage medium stores computer executable instructions for causing one or more processors to perform a method for rights management. The method includes acquiring an operation request; querying from a pre-created rights list according to the operation request, and returning a corresponding processing result; and executing a corresponding operation according to the processing result.

According to the above method, system and non-transitory computer readable storage medium for rights management, the corresponding processing result is obtained by querying from the pre-created rights list according to an operation request, and a corresponding operation is performed according to the processing result, without classification management of various resources or various operations, instead using the unified management, which reduces rights management complexity and improves the convenience of management.

### BRIEF DESCRIPTION OF THE DRAWINGS

FIG. 1 is a schematic diagram showing a method for rights management according to one embodiment of the present invention;

FIG. 2 is a schematic diagram showing pre-creating a rights list according to one embodiment of the present invention;

FIG. 3 is a schematic diagram showing querying a pre-created rights list according to the operation request and returning the corresponding processing result, in FIG. 1;

FIG. 4 is a schematic diagram showing a system for rights management according to one embodiment of the present invention;

FIG. 5 is a schematic diagram showing a system for rights management according to another embodiment of the present invention;

FIG. 6 is a schematic diagram showing a creation module according to one embodiment of the present invention; and

FIG. 7 is a schematic diagram showing diagram showing a query module according to one embodiment of the present invention.

### DETAILED DESCRIPTION OF THE PREFERRED EMBODIMENTS

Reference will now be made in detail to exemplary embodiments of the invention, which are illustrated in the accompanying drawings.

An active defense system can be abstracted to a management of rights. For example, the active defense system has to focus on operations such as modification or deletion of key system files or key user-defined files. The operation can be abstracted to an operation executed by an operation subject on an operation object. For example, in the case of a file is deleted by a process, the process is an operation subject, the file is an operation object and the deletion is an operation mode. The present invention is mainly used for, but not limited to, rights management in the active defense system.

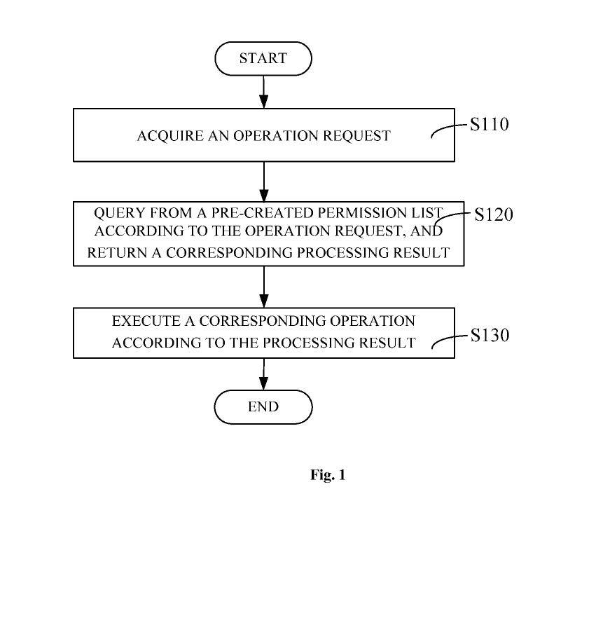

As shown in FIG. 1, according to one embodiment, a method for rights management includes the following steps.

Step S110: acquiring an operation request.

Acquire an operation request that is sent out when a third-party software is operating on a system file, a registry or a process in a computer. The third-party software may be a normal functional software, malicious viruses program, etc. The active defense system intercepts the operation request from the third-party software, and queries its operation rights, so as to interrupt the operation.

Step S120: querying a pre-created rights list according to the operation request, and returning the corresponding processing result.

The returned processing result may be permission, block, or asking the user. The permission refers to the operation is allowed, the block refers to the operation is blocked, and asking the user refers to whether to execute the operation is determined by the user. For example, when an operation request is to delete a key system file, if the processing result is a permission, the key system file will be deleted; if the processing result is block, the key system file will not be deleted; and if the processing result is asking the user, the user will be prompted, and whether to delete the key system file is determined by the user.

Step S130: executing a corresponding operation according to the processing result.

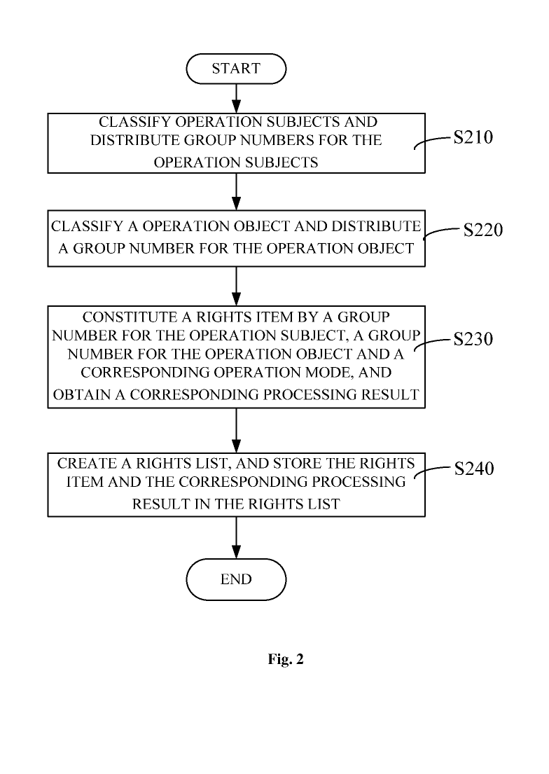

In one embodiment, the above method for rights management includes a step of pre-creating rights list. As shown in FIG. 2, the specific steps of pre-creating rights list may include:

Step S210: classifying an operation subject and distributing a group number for the operation subject.

Classify operation subjects according to predefined criteria. Taking a process operating on a file or a registry for instance, the process is the operation subject, the file or registry is the operation object, and the deletion or modification is the operation mode. Classify processes according to the path of the process, and distribute a group number for the operation subject.

Step S220: classifying an operation object and distributing a group number for the operation object.

If the operation object is a file, then classify the file by the path of the file, and distribute a group number for the operation object. If the operation object is a virus file, then classify the file according to the parent process of the virus, the size of the virus or the type of the file, and distribute a group number for the operation object.

Step S230: constituting a rights item by a group number of the operation subject, a group number of the operation object and a corresponding operation mode, and obtaining a corresponding processing result.

A rights item is composed of a group number of an operation subject, a group number of an operation object and a corresponding operation mode. Each rights item corresponds to a corresponding processing result, such as permission, block, or asking the user.

Step S240: creating a rights list, and storing the rights item and the corresponding processing result into the rights list.

The rights item and the corresponding processing result are stored in the rights list as one record. The rights item includes a group number of an operation subject, a group number of an operation object and a corresponding operation mode, which can be stored in the form of three-dimensional coordinate. In the rights list, the group numbers of operation subjects may be on X-axis, the group numbers of operation objects may be on Y-axis, and the operation modes may be on Z-axis, and the corresponding processing result can be obtained by a convergent point of these three coordinates.

In a further embodiment, an operation request includes operation subject information, operation object information and operation mode information. The operation subject information may include at least one of: the name of an operation subject, the path of an operation subject, etc. The operation object information may include at least one of: the name of an operation object, the path of an operation object, etc. The operation mode information may include at least one of: deletion, modification, creation, etc.

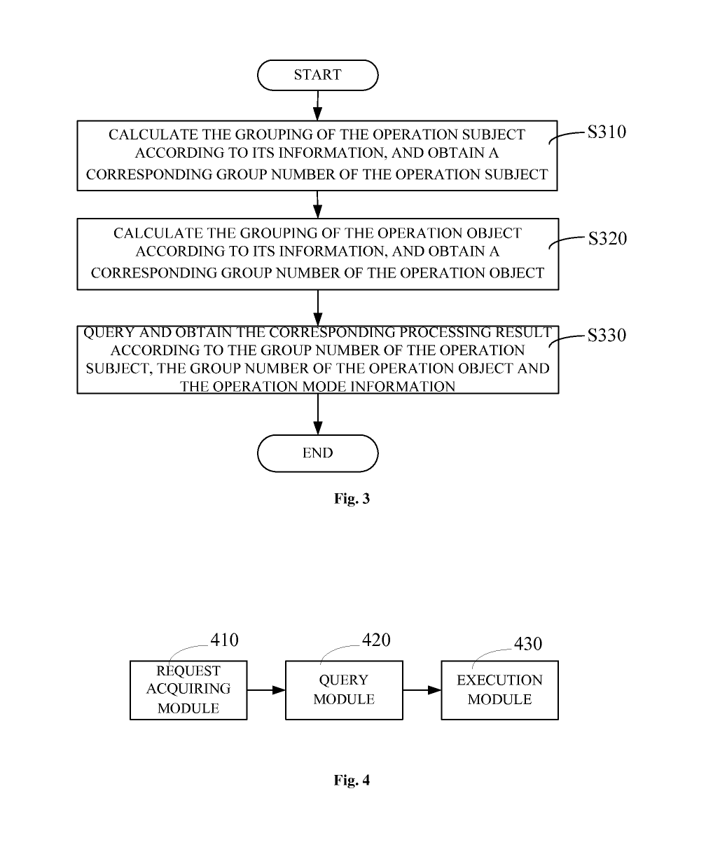

In a further embodiment, as shown in FIG. 3, the step S120 may include the following steps.

Step S310: calculating the grouping of the operation subject according to its information, and obtaining a corresponding group number of the operation subject.

Query a matching operation subject name from the rights list according to the name of the operation subject in the operation subject information, so as to obtain a corresponding group number of the operation subject. The hash value of the operation subject information may also be calculated. The hash value of the operation subject information can be matched with the hash value of the operation subject in the rights list, so as to obtain a corresponding group number of the operation subject.

Step S320: calculating the grouping of the operation object according to its information, and obtaining a corresponding group number of the operation object.

Query a matching operation object name from the rights list according to the name of the operation object in the operation object information, so as to obtain a corresponding group number of the operation object. The hash value of the operation object information may also be calculated. The hash value of the operation object information can be matched with the hash value of the operation object in the rights list, so as to obtain a corresponding group number of the operation object.

Step S330: querying and obtaining the corresponding processing result according to the group number of the operation subject, the group number of the operation object and operation mode information.

The corresponding processing result can be queried and obtained from the three-dimensional coordinate of the rights list after obtaining the group number of the operation subject, the group number of the operation object and operation mode information.

In this embodiment, the rights list is in the form of three-dimensional coordinate, while in other embodiments, the rights item in the rights list may be two dimensional or four dimensional. For example, for an application of generating a monitoring for a file, a process creates a new file, the process as an operation subject is the first dimension, and the new file as an operation object is the second dimension. Based on these two dimensions, whether to monitor or not can be determined when creating the file.

Furthermore, in one embodiment, a non-transitory computer readable storage medium storing computer executable instructions for causing one or more processors to perform a method for rights management is provided. The method has been described hereinbefore.

As shown in FIG. 4, in one embodiment, a system for rights management includes a request acquiring module 410, a query module 420 and an execution module 430.

The request acquiring module 410 is configured to acquire an operation request. The request acquiring module 410 acquire the operation request that is sent out when a third-party software is operating on a system file, a registry or a process in a computer. The third-party software can be a normal functional software, malicious viruses program, etc. The active defense system intercepts the operation request from the third-party software, and queries its operation rights, so as to interrupt the operation.

The query module 420 is configured to query a pre-created rights list according to the operation request, and return the corresponding processing result. The permission refers to the operation is allowed, the block refers to the operation is blocked, and asking the user refers to whether to execute the operation is determined by the user. For example, when an operation request is to delete a key system file, if the processing result is a permission, the key system file will be deleted; if the processing result is block, the key system file will not be deleted; and if the processing result is asking the user, the user will be prompted, and whether to delete the key system file is determined by the user.

The execution module 430 is configured to execute a corresponding operation according to the processing result.

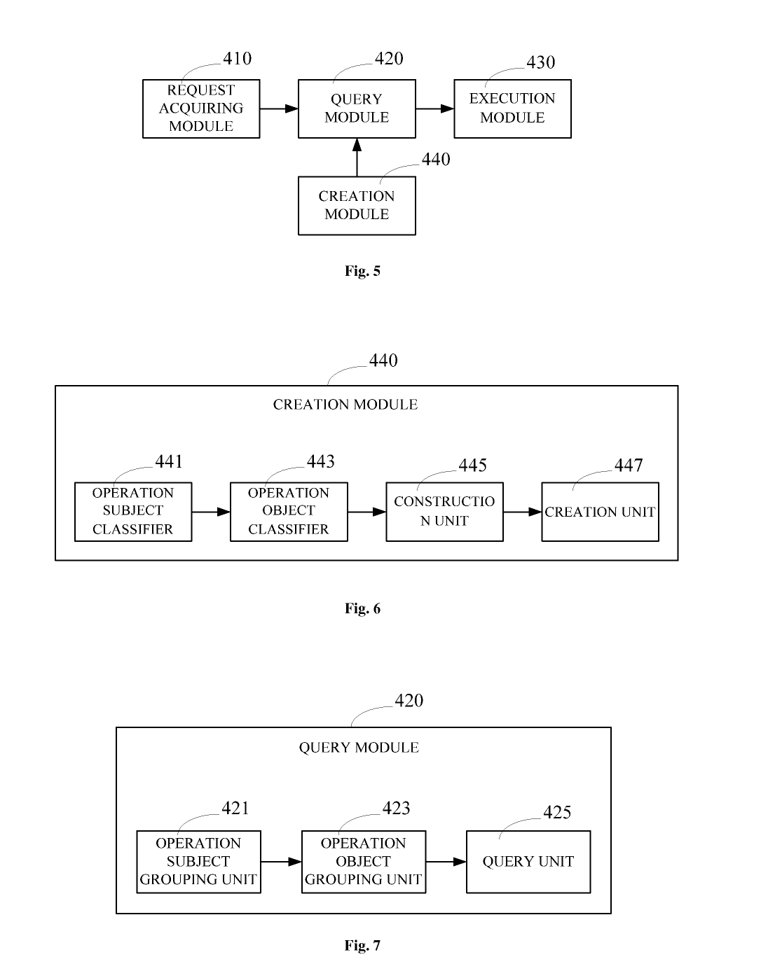

In one embodiment, as shown in FIG. 5, a system for rights management includes a request acquiring module 410, a query module 420, an execution module 430, and a creation module 440 configured to pre-create the rights list.

In a further embodiment, as shown in FIG. 6, the creation module 440 includes an operation subject classifier 441, an operation object classifier 443, a construction unit 445, and a creation unit 447.

The operation subject classifier 441 is configured to classify an operation subject and distribute a group number for the operation subject. The operation subject classifier 441 classifies an operation subject according to predefined criteria. Taking a process operating on a file or a registry for instance, the process is an operation subject, the file or registry is an operation object and the deletion or modification is an operation mode. Classify a process by the path of the process, and distribute a group number for the operation subject.

The operation object classifier 443 is configured to classify an operation object and distribute a group number of the operation object. If the operation object is a file, the operation object classifier 443 classifies the file according to the path of the file, and distributes a group number of the operation object. If the operation object is a virus file, the operation object classifier 443 classifies the file according to the parent process of the virus, the size of the virus or the type of the file, and distributes a group number for the operation object.

The construction unit 445 is configured to constitute a rights item by a group number of the operation subject, a group number of the operation object and a corresponding operation mode, and obtain a corresponding processing result. A rights item is composed of a group number of an operation subject, a group number of an operation object and a corresponding operation mode. Every rights item corresponds to a corresponding processing result, such as permission, block, or asking the user.

The creation unit 447 is configured to create a rights list, and store the rights item and corresponding processing result in the rights list. The rights item and corresponding processing result are stored in the rights list as one record by the creation unit 447. The rights item includes a group number of an operation subject, a group number of an operation object and a corresponding operation mode, which can be stored in the form of three-dimensional coordinate. In the rights list, the group numbers of operation subjects may be on X-axis, the group numbers of operation objects may be on Y-axis, and the operation modes may be on Z-axis, and the corresponding processing result can be obtained by a convergent point of these three coordinates.

In a further embodiment, an operation request includes operation subject information, operation object information and operation mode information. The operation subject information may include at least one of: the name of an operation subject, the path of an operation subject, etc. The operation object information may include at least one of: the name of an operation object, the path of an operation object, etc. The operation mode information may include at least one of: deletion, modification, creation, etc.

In a further embodiment, as shown in FIG. 7, the query module 420 includes an operation subject grouping unit 421, an operation object grouping unit 423, and a query unit 425.

The operation subject grouping unit 421 is configured to calculate the grouping of the operation subject according to its information, and obtain a corresponding group number of the operation subject. The operation subject grouping unit 421 can query a matching operation subject name from the rights list according to the name of the operation subject in the operation subject information, so as to obtain a corresponding group number of the operation subject. The hash value of the operation subject information can also be calculated to match with the hash value of the operation subject in the rights list, so as to obtain a corresponding group number of the operation subject.

The operation subject grouping unit 423 is configured to calculate the grouping of the operation object according to its information, and obtaining a corresponding group number of the operation object. The operation subject grouping unit 423 can query a matching operation object name from the rights list according to the name of the operation object in the operation object information, so as to obtain a corresponding group number of the operation object. The hash value of the operation object information can also be calculated to match with the hash value of an operation object in the rights list, so as to obtain a corresponding group number of the operation object.

The query unit 426 is configured to query and obtain the corresponding processing result according to the group number of the operation subject, the group number of the operation object and the operation mode information. The corresponding processing result can be queried and obtained from the three-dimensional coordinate of the rights list after obtaining the group number of the operation subject, the group number of the operation object and operation mode information.

According to the above method, system and non-transitory computer readable storage medium for rights management, the corresponding processing result is obtained by querying from the pre-created rights list according to an operation request, and a corresponding operation is performed according to the processing result, without classification management of various resources or various operations, instead using the unified management, which reduces rights management complexity and improves the convenience of management.

Moreover, distributing group numbers to the operation subjects and operation objects facilitates the unified management, and it is also accurate and simple for determining the corresponding group numbers by calculating the hash values of the operation subject information and the operation object information.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for rights management, comprising:
acquiring an operation request;
querying from a pre-created rights list according to the operation request, and returning a corresponding processing result; and
executing a corresponding operation according to the processing result.

2. The method of claim 1, further comprising:
pre-creating a rights list,
wherein pre-creating the rights list comprises:
classifying an operation subject and distributing a group number for the operation subject;
classifying an operation object and distributing a group number for the operation object;
constituting a rights item by the group number for the operation subject, the group number for the operation object and a corresponding operation mode, and obtaining a corresponding processing result; and
creating the rights list, and storing the rights item and the corresponding processing result in the rights list.

3. The method of claim 2, wherein the operation request comprises operation subject information, operation object information and operation mode information;
querying from the pre-created rights list according to the operation request, and returning the corresponding processing result comprises:
calculating the grouping of the operation subject according to the operation subject information, to obtain a corresponding group number for the operation subject;
calculating the grouping of the operation object according to the operation object information, to obtain a corresponding group number of the operation object; and
querying to obtain a corresponding processing result according to the group number of the operation subject, the group number of the operation object and the operation mode information.

4. The method of claim 3, wherein calculating the grouping of the operation subject according to the operation subject information, to obtain the corresponding group number of the operation subject comprises:
calculating a hash value of the operation subject information, and matching the hash value of the operation subject information with the hash value of the operation subject in the rights list, to obtain a corresponding group number of the operation subject; and
calculating the grouping of the operation object according to the operation object information, to obtain a corresponding group number of the operation object comprises: calculating a hash value of the operation object information, matching the hash value of the operation object information with the hash value of the operation object in the rights list, to obtain a corresponding group number of the operation object.

5. The method of claim 1, wherein the processing result is permission, block, or asking a user.

6. A system for rights management, comprising:
a request acquiring module, configured to acquire an operation request;
a query module, configured to query from a pre-created rights list according to the operation request, and return a corresponding processing result; and
an execution module, configured to execute a corresponding operation according to the processing result.

7. The system of claim 6, further comprising a creation module, configured to pre-create a rights list; wherein the creation module comprises:
an operation subject classifier, configured to classify an operation subject and distribute a group number for the operation subject;
an operation object classifier, configured to classify an operation object and distribute a group number for the operation object;
a construction unit, configured to constitute a rights item according to the group number for the operation subject, the group number of the operation object and the corresponding operation mode, and obtain a corresponding processing result; and
a creation unit, configured to create a rights list, and store the rights item and the corresponding processing result into the rights list.

8. The system of claim 7, wherein the operation request comprises operation subject information, operation object information and operation mode information; and the query module comprises:
an operation subject grouping unit, configured to calculate the grouping of the operation subject according to the operation subject information, and obtain a corresponding group number of the operation subject;
an operation object grouping unit, configured to calculate the grouping of the operation object according to the operation object information, and obtain a corresponding group number of the operation object; and
a query unit, configured to query and obtain the corresponding processing result according to the group number of the operation subject, the group number of the operation object and the operation mode information.

9. The system of claim 8, wherein the operation subject grouping unit is further configured to calculate a hash value of the operation subject information, match the hash value of the operation subject information with the hash value of the operation subject in the rights list, and obtain a corresponding group number of the operation subject; and the operation object grouping unit is further configured to calculate a hash value of the operation object information, match the hash value of the operation object information with the hash value of the operation object in the rights list, to obtain a corresponding group number of the operation object.

10. The system of claim 6, wherein the processing result is permission, block, or asking a user.

11. A non-transitory computer readable storage medium storing computer executable instructions for causing one or more processors to perform a method for rights management, the method comprising:
acquiring an operation request;
querying from a pre-created rights list according to the operation request, and returning a corresponding processing result; and
executing a corresponding operation according to the processing result.

12. The non-transitory computer readable storage medium of claim 11, wherein the method further comprises pre-creating the rights list; wherein pre-creating the rights list comprises:
classifying an operation subject and distributing a group number for the operation subject;
classifying an operation object and distributing a group number for the operation object;
constituting a rights item by the group number for the operation subject, the group number for the operation object and a corresponding operation mode, and obtaining a corresponding processing result; and
creating the rights list, and storing the rights item and the corresponding processing result into the rights list.

13. The non-transitory computer readable storage medium of claim 12, wherein the operation request comprises operation subject information, operation object information and operation mode information; and querying from the pre-created rights list according to the operation request, and returning the corresponding processing result comprises:
calculating the grouping of the operation subject according to the operation subject information, to obtain a corresponding group number of the operation subject;
calculating the grouping of the operation object according to the operation object information, to obtain a corresponding group number of the operation object; and
querying to obtain the corresponding processing result according to the group number of the operation subject, the group number of the operation object and the operation mode information.

14. The non-transitory computer readable storage medium of claim 13, wherein calculating the grouping of the operation subject according to the operation subject information to obtain the corresponding group number of the operation subject comprises:
calculating a hash value of the operation subject information, matching the hash value of the operation subject information with the hash value of the operation subject in the rights list, and obtaining a corresponding group number of the operation subject;
calculating the grouping of the operation object according to the operation object information, to obtain the corresponding group number of the operation object comprises: calculating a hash value of the operation object information, matching the hash value of the operation object information with the hash value of the operation object in the rights list, and obtaining a corresponding group number of the operation object.

15. The non-transitory computer readable storage medium of claim 11, wherein the processing result is permission, block, or asking a user.
